(19) United States
(12) Patent Application Publication
(10) Pub. No.: US 2016/0067877 A1
(43) Pub. Date: Mar. 10, 2016

(54) Cutting Head Assembly For Slicing Food

(71) Applicant: Frito-Lay North America, Inc., Plano, TX (US)

(72) Inventors: Kevin C. Cogan, Oak Point, TX (US); Peter L. Hayes, Flower Mound, TX (US); David Lester Hickie, Market Harborough (GB); Greg Paul Hilliard, Leicester (GB); Marc Lingier, Veurne (BE); Nico Vandecasteele, Veurne (BE)

(21) Appl. No.: 14/478,052

(22) Filed: Sep. 5, 2014

(51) Int. Cl. B26D 7/26; B26D 1/03; B26D 7/06

(52) U.S. Cl. CPC B26D 7/2614; B26D 7/0691; B26D 1/03

(57) ABSTRACT

An improved cutting head assembly with an angled blade for slicing that can be used with a centrifugal-type slicer to provide an increased yield. The blade comprises a cutting edge that cuts a product, for example, a potato, in a cutting direction. A tangent to the cutting edge is at an angle away from the normal plane of a cutting direction for the blade. For example, if the cutting edge is a straight line and the cutting direction is horizontal, then the cutting edge is at an angle away from vertical.

### BACKGROUND OF THE INVENTION

1. Technical Field

The present invention relates to a modified food-slicing shoe for a slicing system that provides for the commercial production of sliced food products. A standard interchangeable food product slicing shoe and its blade are modified to produce a blade that is angled relative to a normal plane to the cutting direction such that the cutting edge of the blade is not perpendicular to the direction the blade travels while cutting.

2. Description of Related Art

There are a number of methods for slicing food products as a pre-processing step to producing food products in the industry. Various machines and methods have been manufactured for the commercial production of ready-to-eat food products, such as potato or other vegetable or fruit chips, to produce chips of a variety of textures and sizes to appeal to the different preferences of consumers.

One such machine is a centrifugal type slicer, such as the one disclosed in U.S. Pat. No. 5,694,824 to Jacko et al., which is directed to “a cutting head for slicing a food product.” Jacko et al. describes a slicing machine typically used to cut raw produce, usually in the form of whole potatoes, into slices to create, for example, potato chips. As seen in FIG. 1, depicting the prior art, potatoes are fed through a feed hopper 10 onto an impeller 14 with inwardly extending partitions, which is surrounded by a stationary cutting head assembly 12. A motor (not pictured) rotates the impeller 14 via a gear box 16, creating a centrifugal force that causes the potatoes to move outwardly against the partitions and the inner surface of the cutting assembly. As further detailed in FIGS. 2 and 3, the cutting assembly includes a series of slicing shoes with cutting blades 22. The slicing shoe consists of a support 20 having a flat blade 22 attached with bolts 26. As the product passes by the cutting blades of the slicing shoes, potato slices are quickly produced and passed on through a chute 18 for further processing into a ready-to-eat potato snack chips.

A centrifugal slicing machine, such as the one disclosed in Jacko et al., is manufactured and sold by Urschel Laboratories, Inc. of Valparaiso, Ind., USA. These machines allow for the production of sliced potatoes. For example, as shown in FIG. 4, an impeller 40 rotates in a direction 45. As a result of centrifugal force, potatoes 42 are pushed against a stationary cutting head 12. The cutting head comprises blades 22 with vertically oriented cutting edges 25. Once a potato 42 contacts a cutting edge, a potato slice 44 will be cut in a direction that is essentially parallel to the plane of the blade. This is the cutting direction 47, which is substantially horizontal as shown in FIG. 4.

Because the cutting edge is perpendicular to the cutting direction, the cutting action results in an essentially square impact with the potatoes. This imparts a relatively high cutting force on the potatoes. The cutting force on the potatoes is the force normal to the cutting edge to which a potato is subjected when pushed into the blade at the rotational speed of the impeller. Reducing the cutting force reduces cell damage to potatoes during the cutting process because the cutting force results in potato cells being ruptured and disturbed. The shattering effect due to the cutting force can damage the cells of the potatoes 2-5 cell layers deep and cause damaged cells to release starch granules. In some cases, the high cutting force results in a loss of 10 to 15 wt % of starch present in the potatoes before cutting. This represents a significant increase in the costs of raw materials for commercially producing a given amount of product. In fact, even a starch loss of 1 wt % or less is commercially significant.

In addition to the damage that cutting force can cause to a sliced product, the cutting force can also damage blades, dull blades, and shorten their useful life. This leads to costs, not only for replacement blades, but also as a result of decreased yield. For example, if the blades are dull, they can fail to provide a clean cut through a product. This can, in turn, result in damage to the product cells and a loss of starch.

One approach to reducing the cutting force on a potato is to slow down the translational velocity of the potatoes being cut. This can be done by decreasing the radius of a cutting head assembly or reducing the angular velocity of an impeller that is used to force potatoes against the cutting head. However, if the translational velocity of the potatoes is reduced potatoes will not be cut as quickly and the throughput of potatoes through the cutting head assembly will be reduced. In other words, over a given period of time, the number of slices performed by the cutting head will be decreased.

Another problem that can occur in cutting food products is the buildup of material on the blade. For example, this material can be debris, starch, or material from the products that are being cut. The buildup of this material can impede performance of the cutting blades, dull the cutting blades, and increase the damage done to sliced products as they are cut. Accordingly, the buildup of material on a blade can also result in a reduced yield.

Consequently, there is a need for an improved method and apparatus for cutting food products on a commercial scale. In addition, there is a need to increase the yield of sliced food product obtained from a given mass of the unsliced food product. Further, there is a need to reduce the starch loss that occurs when a food product, for example, a potato, is cut. There is a need to reduce the cutting force on blades and the damage that occurs to cutting blades when slicing a product. Additionally, there is a need to increase blade life. Likewise, there is a need to reduce the cutting force involved in cutting potatoes while maintaining or increasing the rate at which potatoes are sliced. There is also a need to prevent or reduce the buildup of material on the cutting blades. Further, there is a need for a modified slicing shoe capable of providing increased yield and a reduction in starch loss. Accordingly, there is a need for modifications to the cutting blades that are currently available and their corresponding slicing shoes and cutting heads.

### SUMMARY OF THE INVENTION

The present invention is a method and apparatus for cutting food products. It provides a modified cutting head with an angled blade for slicing.

In a first aspect, the invention provides a cutting head, with a central axis, an interior, an exterior, a top, and a bottom, for slicing food product to form sliced food product. The cutting head comprises at least one blade secured to the cutting head, wherein the at least one blade comprises a cutting edge inwardly directed towards the interior of the cutting head and oriented to cut the food product as the food product rotates along the interior of the cutting head in a direction of rotation. A portion of the cutting edge comprises a plurality of points, wherein for each point in the plurality of points, a corresponding plane for the point passes through the point and contains the central axis. For each point in the plurality of points, as viewed from the central axis and along the corresponding plane for the point, a tangent to the cutting edge at the point is at an angle to the corresponding plane.

In a second aspect the invention provides a cutting head, with a central axis, an interior, an exterior, a top, and a bottom, for slicing food product to form sliced food product, said cutting head oriented with respect to a first plane that is a planar projection of the central axis through a point on the cutting head, which cutting head is also oriented with respect to a second plane. The second plane passes through the point, is perpendicular to the first plane, and is parallel to the central axis. The cutting head is also oriented with respect to a first line that is an orthogonal projection of the central axis onto the second plane and passes through the point on the cutting head. The cutting head comprises at least one blade secured to the cutting head, wherein the at least one blade comprises a cutting edge. The cutting edge is inwardly directed towards the interior of the cutting head and oriented to cut the food product as the food product rotates along the interior of the cutting head in a direction of rotation. The point on the cutting head is a point on the cutting edge and a second line is a tangent to the cutting edge at the point. A third line is an orthogonal projection of the second line onto the second plane. For each point along a portion of the cutting edge, the first line and the third line are at an angle.

In a third aspect the invention provides a method for making a sliced food product using a centrifugal-type slicing machine, said slicing machine having an impeller with an axis of rotation surrounded by a cutting head. The cutting head comprises at least one slicing shoe, wherein each said at least one slicing shoe has an interior, an exterior, a top, a bottom, a first end, a second end, and at least one blade secured to the first end of said slicing shoe. The method comprises the steps of (a) inserting at least one food product into said cutting head; (b) causing said impeller to rotate such that the at least one food product is forced away from the axis of rotation and towards the interior of said at least one slicing shoe; and (c) slicing said at least one food product with a cutting edge of said at least one blade. The cutting edge is inwardly directed towards the impeller to slice the at least one food product in a cutting direction at each point along a length of the cutting edge. A tangent to the cutting edge is oriented at an angle away from a normal plane to the cutting direction at each point along a portion of the length of the cutting edge, thereby producing sliced food products.

In a fourth aspect the invention provides a slicing shoe having first and second ends for use with a centrifugal-type slicer. The centrifugal-type slicer has a cutting head and an impeller that rotate unsliced food products against the cutting head in a direction of rotation for the production of sliced food products. The slicing shoe comprises a blade with a cutting edge inwardly directed towards the impeller. The cutting edge is oriented to slice the unsliced food products in a cutting direction at each point along a length of the cutting edge. A tangent to the cutting edge is oriented at an angle away from a normal plane to the cutting direction at each point along a portion of the length of the cutting edge.

The inventors have discovered a new and inventive apparatus and method for cutting a food product. In one embodiment, the invention is useful for the commercial production of food products. In another embodiment, the invention increases the yield of sliced food product that can be obtained from a given mass of the unsliced product. In another embodiment, the invention reduces starch loss that occurs when a food product, for example, a potato, is cut. In another embodiment, the invention reduces the raw material costs necessary to produce a given amount of food product. In another embodiment, the invention reduces the cutting force on blades. In another embodiment, the invention reduces the damage that occurs to cutting blades when slicing product. In another embodiment, the invention increases blade life. In another embodiment, the invention reduces the cutting force involved in cutting potatoes while maintaining or increasing the rate at which potatoes are sliced. In another embodiment, the invention prevents or reduces the buildup of material on a blade that would otherwise impede performance. In another embodiment, the invention modifies the cutting blades, the corresponding slicing shoes, and the corresponding cutting heads presently available to obtain certain improvements in cutting.

For example, the inventors have discovered that by changing the orientation of the cutting blade, the mechanics of cutting can be modified, and the impact of the cutting force on a potato can be reduced. Furthermore, by reducing the cutting force on a potato, the damage done to the potato itself as a result of being ruptured or disturbed is decreased. Accordingly, the leakage of cellular material from the potato cells, including, for example, starch, can be decreased. As a result, less potato material is lost due to cutting and the yield associated with cutting potatoes can be increased.

Another advantage of the invention is that the throughput through a cutting head assembly can be maintained or increased relative to slicing with an unmodified cutting head assembly. For example, relative to an unmodified cutting head, a modified cutting head assembly according to the present invention can slice product at the same rate while increasing the yield. As another example, a modified cutting head assembly according to the present invention can slice product at the same yield while increasing the slicing rate. As yet another example, a modified cutting head assembly according to the present invention can slice product at a faster rate while maintaining or increasing yield relative to an unmodified cutting head.

In one embodiment, the present cutting system improves upon traditional continuous, high-throughput processes for cutting food products by increasing the yield of the cutting process. For example, in one embodiment, modified shoe slicing segments are formed to fit within a standard cutting assembly such as one typically used in centrifugal slicing known in the industry for commercial production. The cutting assembly surrounds a rotatable impeller with blades, which is caused to spin by a motor. Raw or whole produce is fed through a food product hopper onto the impeller and the centrifugal force then causes the food products to move away from the axis of rotation and towards blades on the inner sides of the stationary cutting assembly. As the products impact the blades, slices are continuously cut from the products in a cutting direction. Because the cutting edge of the blades is oriented at an angle away from vertical, the cutting edge is not perpendicular to the cutting direction. This increases the yield of sliced food product obtained from the unsliced food product. The sliced food product can then be further processed to reduce the moisture of the products, producing ready-to-eat sliced snacks.

The inventors have also discovered that angling of the blade facilitates cleaning the blade as it passes through food products. Accordingly, one embodiment of the invention is effectively self-cleaning because a component of the cutting force acts along the blade as a cleaning force, which effectively wipes the blade as it is used to cut product.

Other aspects, embodiments and features of the invention will become apparent from the following detailed description of the invention when considered in conjunction with the accompanying drawings. The accompanying figures are schematic and are not intended to be drawn to scale. In the figures, each identical or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a schematic view of a known centrifugal slicing device with a prior art cutting assembly.

FIG. 2 is a view of a conventional slicing shoe and blade.

FIG. 3 depicts perspective view of a prior art cutting assembly.

FIG. 4 is a partial, perspective view demonstrating the known slicing of food products using a centrifugal slicing machine.

FIG. 5a is a schematic illustration depicting a blade with a vertically oriented cutting edge.

FIG. 5b is a schematic illustration depicting a blade with a cutting edge oriented at an angle away from vertical.

FIG. 6a illustrates a perspective view of one embodiment of the invention depicting slicing shoes arranged generally cylindrically to produce a cutting assembly.

FIG. 6b is an elevational view of an interior side of one embodiment of the invention depicting a slicing shoe with an angled blade.

FIG. 7a is a perspective view of an interior side of one embodiment of the invention depicting a slicing shoe for use with an angled blade and a sand gate.

FIG. 7b is a perspective view of an exterior side of one embodiment of the invention depicting a slicing shoe for use with an angled blade and a sand gate.

FIG. 7c illustrates a perspective view of an embodiment of the invention depicting slicing shoes, each comprising an angled blade and sand gate, arranged generally cylindrically to produce a cutting assembly.

FIG. 7d is a perspective view of an exterior side of one embodiment of the invention depicting adjacent slicing shoes with an angled blade and a sand gate.

FIG. 7e is a perspective view of an interior side of one embodiment of the invention depicting adjacent slicing shoes with an angled blade and a sand gate.

FIG. 7f is a perspective view of an interior side of one embodiment of the invention depicting an angled blade and a sand gate.

FIG. 8a is a schematic of a cutting head depicting an angle between a tangent to a cutting edge at a point and a first plane containing the central axis of the cutting head and passing through the point.

FIG. 8b is a schematic showing some of the components of FIG. 8a, but without the cutting head so that the angle between the tangent and the first plane as projected onto a second plane can be seen more easily.

### DETAILED DESCRIPTION OF THE INVENTION

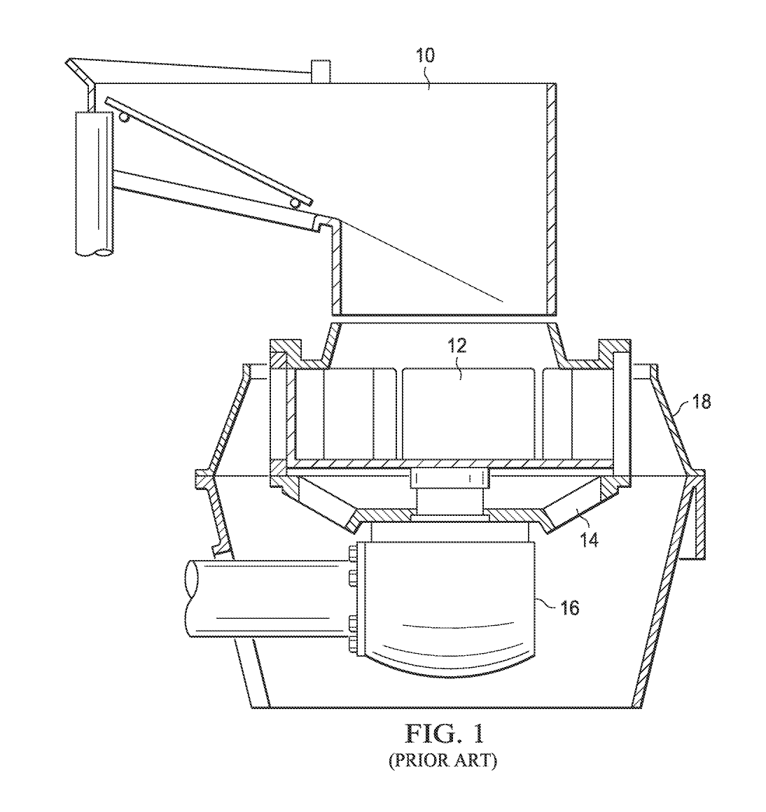

A known centrifugal slicer is seen in FIGS. 1-4. Only those components necessary for an understanding of this invention will be described. The stationary cutting assembly 12 comprises eight slicing shoes positioned in a generally cylindrical shape within which an impeller 14 is rotatably mounted on a gear box 16 to be driven by a suitable driving means such as a motor (not shown). Product that enters through the feed hopper 10 is caused by the centrifugal forces of the rotation to move outwardly around the interior of the cutting assembly 12, which comprises a plurality of slicing shoes, each having a stationary slicing blade 22.

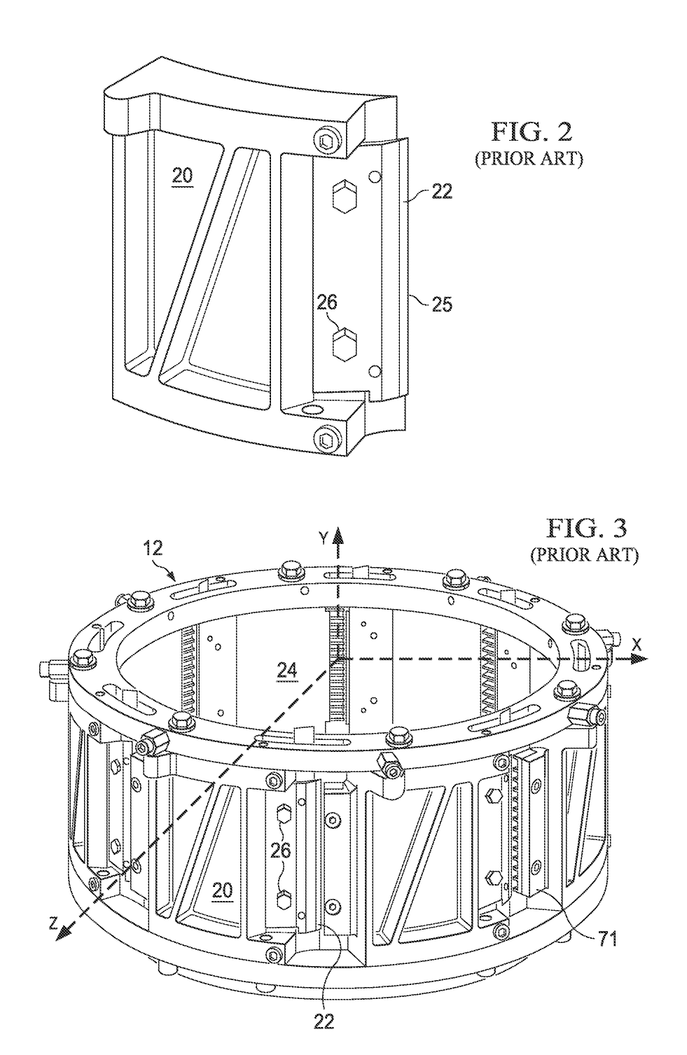

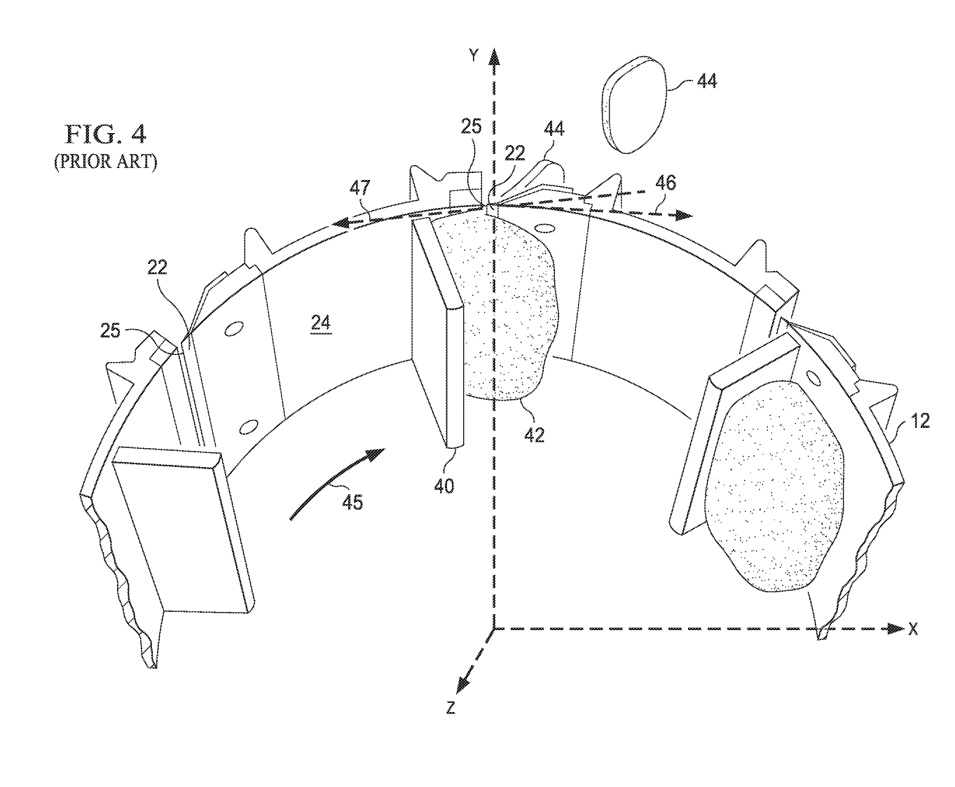

As shown in FIGS. 2 and 3, each blade 22 is generally straight, having edges that fall within the same plane, and vertically oriented. Each straight blade 22 is attached at a front end of the support 20 by means of bolts 26. A sand gate 71, also having a straight edge, is attached at a rear end of the support 20 to trap sand, dirt and other kinds of debris. In some embodiments the support is made of stainless steel, bronze, or plastic although other materials can also be used. In some embodiment the support 20 is made using a casting process or molding process, although other processes can also be used. Referring to FIG. 4, the impeller 40 rotates in the direction of the arrow 45, causing food product 42 to move against the flat interior walls 24, causing the straight blades 22 to create flat slices 44.

When cooked by means such as frying or baking, these food product slices result in ready-to-eat food products. Food products suitable for use with the present invention include without limitation any foodstuff, for example, cheese, produce, potatoes, apples, pears, beets, yucca, sweet potatoes, tomatoes, mangos, eggplants, cucumbers, zucchinis, etc. Although, some embodiments of the invention can also be used to cut other sliced products, including, for example, non-food products.

As shown in FIG. 4, product is cut in a cutting direction 47. Because the blades are directed inwardly, the cutting direction 47 is not exactly tangential 46 to the impeller's direction of rotation 45. In other words, because the blade is at an angle to the tangential direction 46, the cutting direction will also be at an angle to the tangential direction. In FIG. 4, both the cutting direction 47 and the tangential direction 46 are horizontal while the cutting edges 25 are essentially vertically oriented. Thus, the cutting edges are perpendicular to the cutting direction.

As potatoes are pushed against flat blades, as shown in FIG. 4, the flat blades produce flat slices 44, which in some cases contain some texture along the surface. For example, a blade having a number of waves or ridges along its cutting edge 25 produces either a wavy or ridged chip, respectively. Other blades can produce folded or curled shapes. However, all of these blades have cutting edges 25 that are substantially perpendicular to a cutting direction 47.

For consistency with the figures, the blades are described as vertically oriented and the cutting direction is referred to as horizontal; however, other orientations can also result in a cutting edge that is perpendicular to a cutting direction. For example, FIG. 4 shows a cylindrical cutting head 12 with a central axis corresponding to the Y-axis of a Cartesian coordinate system. A blade 22 is generally oriented along the circumference of the cutting head and the cutting edge 25 is parallel to the Y-axis. The cutting edge cuts potatoes 42 in a cutting direction 47 that is parallel to the X-Z plane and perpendicular to the Y-axis. Thus, the cutting edge is oriented perpendicular to the cutting direction. However, if the axis of rotation, in this case the Y-axis, were tilted, the blades would no longer be perfectly vertically oriented, but they would still be perpendicular to the cutting direction, which would also be titled by the same amount as the axis of rotation.

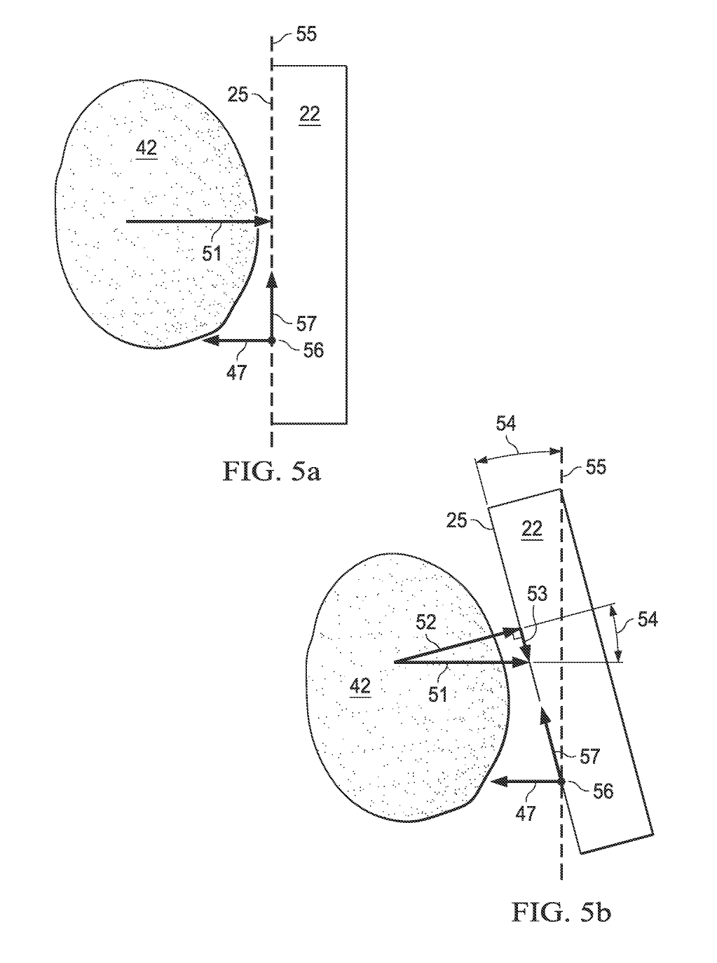

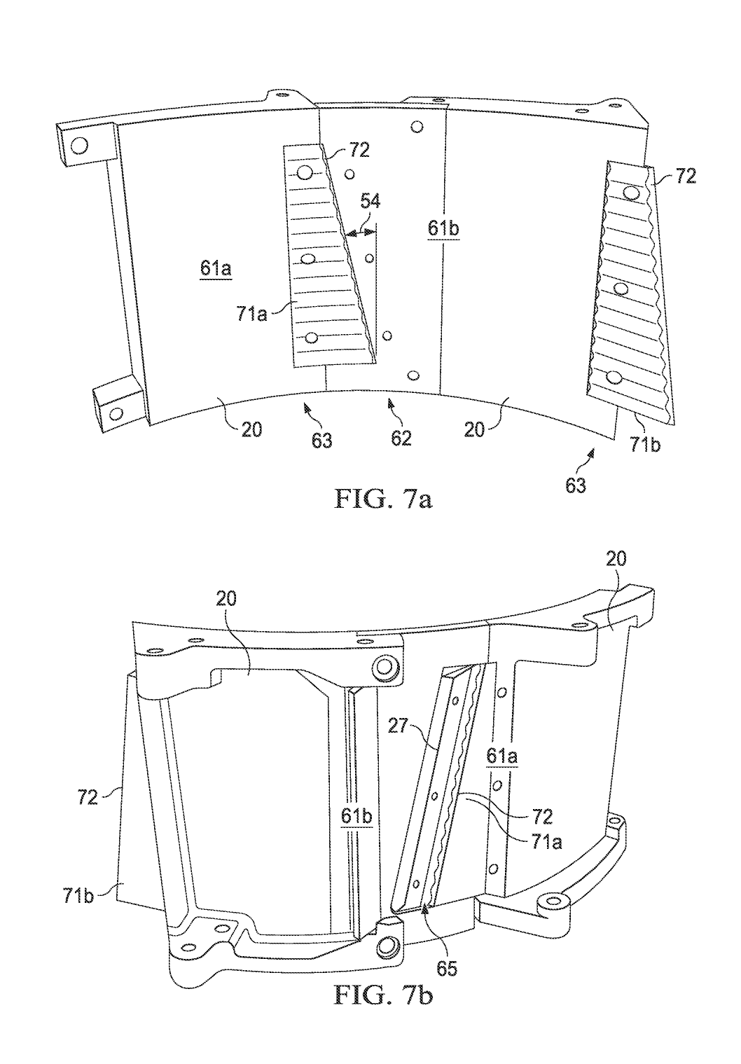

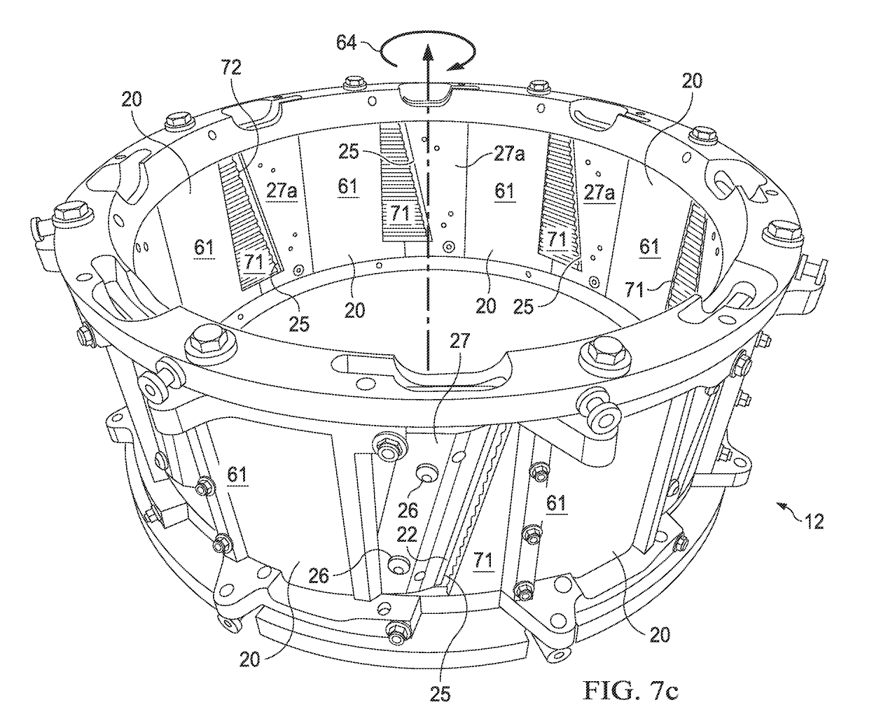

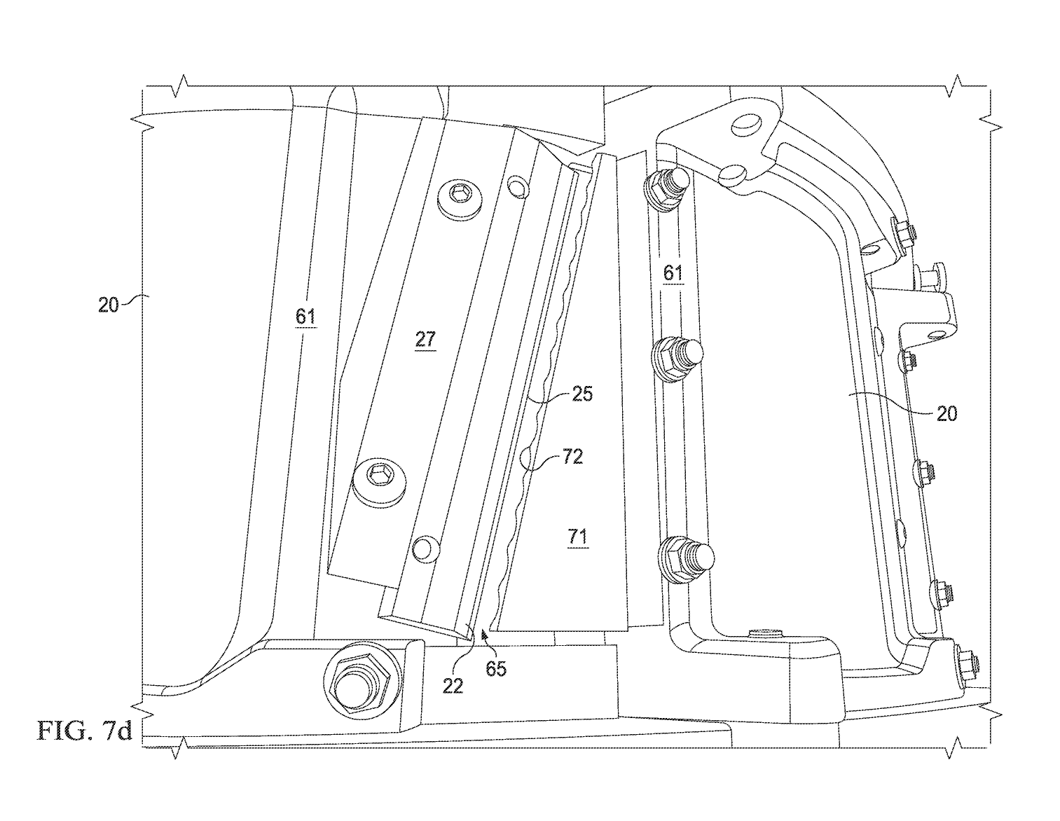

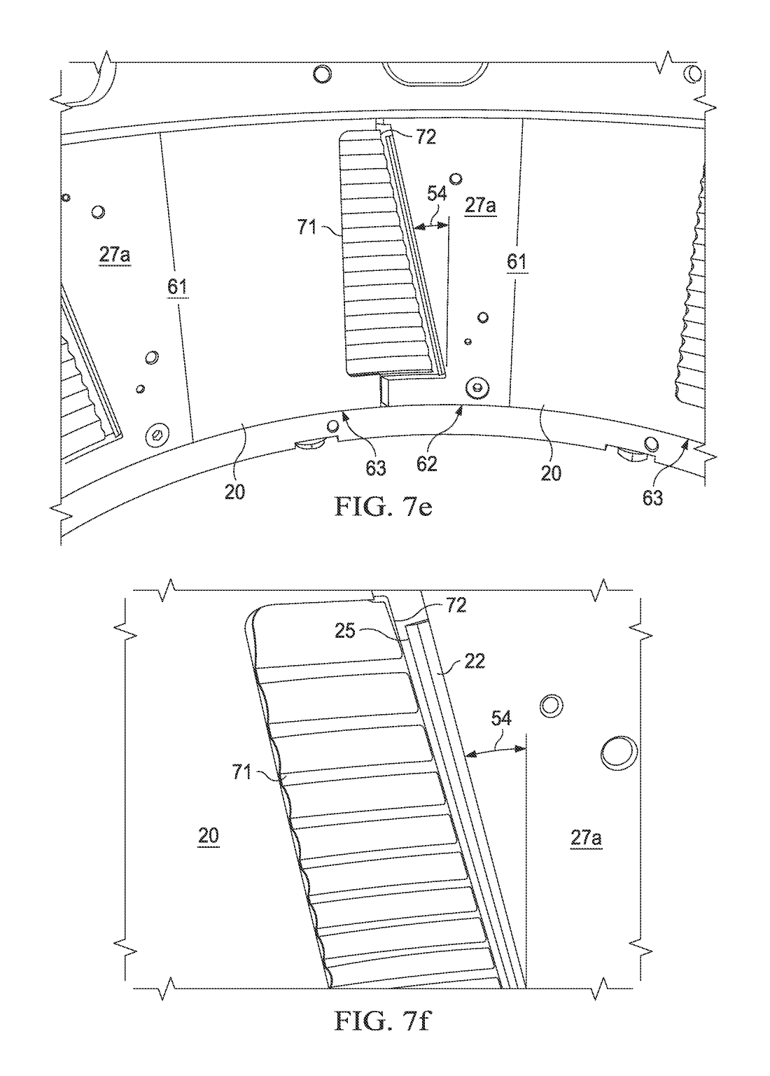

In contrast, the slicing shoes of the present invention comprise cutting edges that are not perpendicular to the cutting direction. FIGS. 5a and 5b illustrate this principle. In FIG. 5a, a blade 22 cuts a potato 42 in a horizontal cutting direction 47 at a point 56 along the length of the cutting edge. The potato is forced against the blade with a total force 51 imparted by the impeller. Because the vertically oriented cutting edge 25 is perpendicular to the total force, the cutting force on the potato is equal to the total force. However, in FIG. 5b, the cutting edge 25 is at an angle of tilt 54 away from vertical and the plane 55 that is substantially perpendicular to the cutting direction. As a result, the cutting edge is not perpendicular to the total force 51. The total force is resolved into a cutting force 52 that is perpendicular to the cutting edge and a cleaning force 53 that is parallel to the cutting edge. Thus, although the cutting direction and the total force are the same in both FIGS. 5a and 5b, the cutting forces are not the same. Rather, the cutting force in FIG. 5b is reduced. For example, in FIG. 5b, the cutting force 52 is equivalent to the total force 51 multiplied by the cosine of the angle of tilt 54. Meanwhile, the cleaning force 53 is equivalent to the total force 51 multiplied by the sine of the angle of tilt 54. While FIGS. 5a and 5b show a positive angle of tilt 54 away from vertical 55 and toward the direction from which the potato 42 approaches the blade 22, the angle of tilt 54 can also be negative and away from the direction from which the potato 42 approaches the blade 22. Using a positive angle of tilt 54 can be useful, for example, to provide a cleaning force 53 that keeps the potato 42 located toward the base of the impeller. In some embodiments, using a positive angle of tilt 54 permits locating the widest part of the sand gate (e.g. sand gates 71a, 71b in FIG. 7a) at the base or bottom of the slicer head, which is where most of the debris (e.g. stones, dirt) will pass through the sand gate. In such an embodiment, using a positive angle of tilt 54 results in less of a probability of damage to the cutting head assembly 12 (e.g., damage to the blades 22) when compared to using a negative angle of tilt 54. For example, in some embodiments, if a negative angle of tilt 54 is used, the debris that falls to the bottom of the cutting head assembly 12 would have a narrower sand gate area to pass through when compared to the sand gate area at the bottom of a sand gate (e.g. sand gates 71a, 71b) when a positive angle of tilt 54 is used. In such an embodiment using a negative angle of tilt 54, the debris can stay in the slicer longer and can be more likely to cause damage to the cutting head assembly 12. Although, an embodiment with a negative angle of tilt 54 can be less desirable, it still provides advantages over existing technology and is considered to be within the scope of the disclosed invention.

Because a component of the total force 51 is resolved into a cleaning force 53 that is parallel to the cutting edge 25, the cleaning force 53 acts to effectively wipe away material that would otherwise build up on the blade 22. In other words, any material that might be present on the blade 22 before cutting will be pushed in the direction of the cleaning force 53 during the cutting. This has the effect of continuously cleaning blade 22 as it is being used to cut products. This can be advantageous as material that builds up on the blade can act as sandpaper and increase the damage done to a product as it is cut.

For FIGS. 5a and 5b the vectors representing the cutting direction 47 are all parallel. However, in some embodiments of the invention, the vectors representing the cutting direction 47 change along the length of the cutting edge 25 as a result of curvature in the shape of the blade 22 and the cutting edge 25. Accordingly, some additional definitions are useful for generalizing the previous description to more complicated geometries. In general, cutting direction 47 for any given point 56 along the cutting edge is given by a vector parallel but opposite to the direction that a piece of potato 42 contacting the point on the cutting edge will travel along the blade as the piece of potato is cut. The plane 55 that is perpendicular to the cutting direction 47 at any given point 56 along the length of the cutting edge 25 can vary. Likewise, the direction of the tangent 57 to the cutting edge 25 can change for different points 56 along the length of the cutting edge 25. Furthermore, at any given point 56 along the cutting edge 25, the angle 54 between the normal plane 55 to the cutting direction 47 and the tangent 57 to the cutting edge 25 can vary.

For example, turning again to FIG. 5a, at a point 56 along the length of the cutting edge 25 the blade 22 cuts the potato 42 in a horizontal cutting direction 47. At the point 56, the plane 55 that is perpendicular to the cutting direction 47 is parallel to the tangent 57 to the cutting edge 25. Accordingly the tangent 57 to the cutting edge 25 is parallel to the normal plane 55 to the cutting direction 47 at the point 56 along the length of the cutting edge 25. In this situation, the cutting force on the potato is high and there is no cleaning force component.

In contrast, the cutting force is reduced in FIG. 5b. At the point 56, the plane 55 that is perpendicular to the cutting direction 47 is not parallel to the tangent 57 to the cutting edge 25. Accordingly the tangent 57 to the cutting edge 25 is oriented at an angle 54 away from the normal plane 55 to the cutting direction 47 at the point 56 along the length of the cutting edge 25. In this situation, the cutting force on the potato is reduced relative to the cutting force for a non-angled cutting edge and there is a cleaning force component.

To further increase the yield of the cutting process, the angle of the cutting edge can be increased. For example, in one embodiment, the angle of the cutting edge can be increased to 45 degrees away from vertical and the angle may be either positive or negative. In other embodiments, the angle of the cutting edge away from vertical is 0°-45°, 1°-45°, 3°-42°, 12°-40°, 15°-35°, 20°-30°, 3°-30°, 5°-10°, 12°-15°, 15°-20°, 30°-40°, 40°-45° or ranges formed by combining any of the endpoints of the previously mentioned ranges. In other embodiments, the angle of the cutting edge can be even greater (e.g. up to 50°, 60°, 70°, or 80° away from vertical, or even any angle less than 90°) but the larger the angle away from vertical, the longer a shoe must be from front to back and the greater the diameter of the cutting head must be because the height of the cutting shoe is essentially set by the height needed to extend across a potato. Given that the height is set, the closer the angle of the cutting edge is to providing a horizontal cutting edge, the greater the length required for the blade. For example, if a straight blade starts at the top and first end of a shoe and also extends all the way to the bottom of the second end of the shoe, the blade can be quite long if the angle of the blade away from vertical is close to 90°. In one embodiment, in order to avoid modifications to existing equipment, it can be useful to use a cutting edge at an angle away from horizontal of approximately 12 degrees. Although, depending upon the design of the embodiment, greater angles can also be used. Generally, a greater angle can be desirable because it reduces the cutting forces on potatoes and increases the yield of cutting potatoes.

Again with reference to FIGS. 5a and 5b, as the angle 54 of the cutting edge 25 away from vertical increases from 0° to 90°, the cutting edge 25 moves from being in front of the blade 22 to being below of the blade 22. As the angle 54 increases from 90° to 180°, the cutting edge 25 moves from being below the blade 22 to being behind the blade 22. As the angle 54 increases from 180° to 270°, the cutting edge 25 moves from being behind the blade 22 to being on top of the blade 22. As the blade 22 completes a full 360° rotation and as the angle 54 increases from 270° to 360°, the cutting edge 25 moves from being on top of the blade 22 to being in front of the blade 22.

As used herein, when the cutting edge 25 is in front of the blade, it means that as products approach the blade 22 it will contact the cutting edge 25 before contacting the rest of the blade 22. If the cutting edge 25 is behind the blade, it means that as product approaches the blade 22, it will contact some part of the blade 22 besides the cutting edge 25, because the cutting edge 25 is at the back end of the blade 22. With reference again to the previous discussion regarding a full 360° rotation of the cutting edge 25, if the angle 54 of the cutting edge 25 results in an orientation of the blade 22 and cutting edge 25 such that the cutting edge 25 is behind the blade 22, the angle 54 between the cutting edge 25 and a reference line or plane 55 (e.g. vertical) can be maintained, but the direction of the blade 22 will need to be reversed so the cutting edge 25 is at the front of the blade 22 with respect to approaching product. Accordingly, the cutting edge 22 can be oriented to cut food product as the product rotates along the interior of the cutting head in a direction of rotation. Put another way, the blade 22 can comprise a cutting edge 25 oriented opposite the direction of rotation.

Because the direction of the blade would need to be reversed for angles greater than 90° to less than 270°, an angle in this range is essentially equivalent to the angle plus 180°. If the resulting angle is greater than 360°, the resulting angle can be converted to an equivalent angle less than 360° by subtracting 360°.

In reducing the cutting force, the inventors found that simply reducing the rotational speed of an impeller in a centrifugal-type cutting machine was not always viable or desirable. For example, a certain rotational speed must be maintained to prevent potatoes or other products from bouncing off the wall of the cutting head. If bouncing does occur, it results in incomplete slices, referred to as scrap. These pieces are scrap because they fall through a conveyor belt on the way to a cooking unit and are lost. In addition to maintaining the necessary rotational speed to prevent bouncing, a high rotational speed can also be desirable to provide a high product throughput.

The inventors have discovered that the use of an angled blade for slicing in accordance with the present invention can reduce cutting force without reducing the rotational speed of an impeller. Accordingly, some embodiments of the invention can reduce impact speed while preventing bouncing and maintaining or increasing product throughput.

The inventors have also discovered that the invention can be useful for reducing the cutting force on products with greater mass. For example, if products of multiple sizes are placed in a centrifugal-type slicer, the centripetal force acting on the products varies with the mass of the products. The heavier products have a greater centripetal force while the products with less mass experience less centripetal force. The angled blades of the present invention can help reduce the cutting forces on the larger potatoes even more than it reduces the cutting forces on the smaller potatoes. In one embodiment, given lighter and heavier products rotated at an angular velocity, the reduction in starch loss for heavier products is greater than that for the lighter products. Accordingly, for heavier products, the reduction in starch loss can be even greater than it is for lighter products, and some embodiments of the invention, when used with larger potatoes, provide an even greater improvement in yield. Furthermore, in some embodiments, if larger potatoes are sorted out from smaller potatoes, then the larger potatoes could be rotated at a slower velocity than smaller potatoes to further aid yield improvement. Alternatively, the larger potatoes can be sliced with cutting edges at a greater angle to further increase yield improvement.

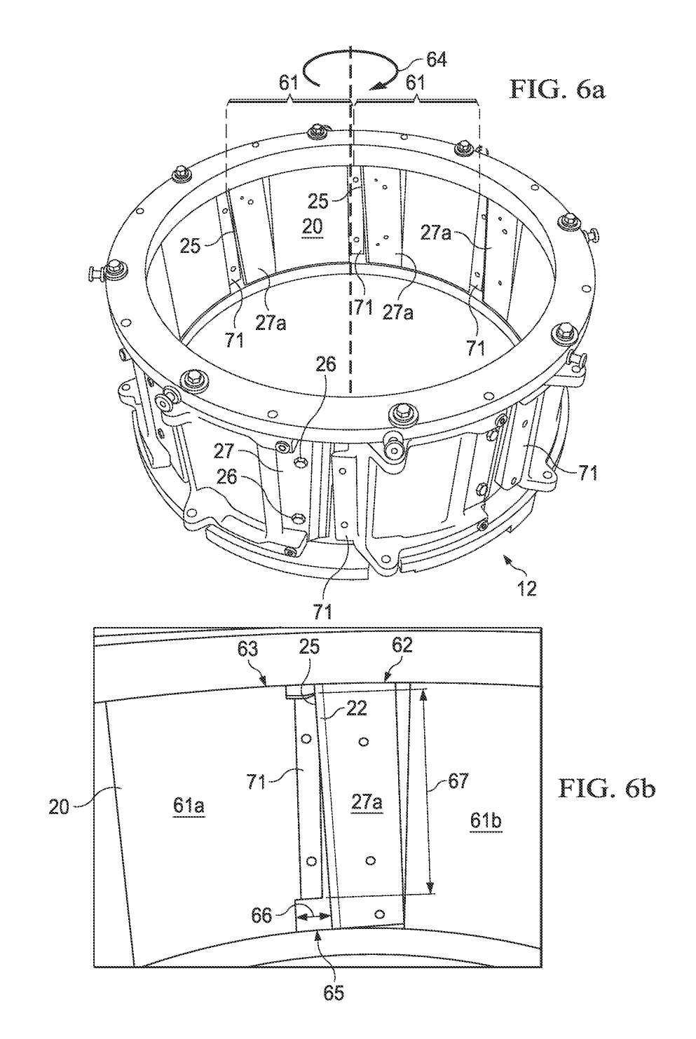

FIGS. 6a and 6b depict a first embodiment of the invention comprising a cutting head 12 with angled blades. FIG. 6a shows a perspective view of cutting head 12. The cutting head comprises slicing shoes 61 arranged in a spaced relation to one another to form a generally cylindrical shape for placement around a rotatable impeller (not shown) of a centrifugal-type slicing machine having an axis of rotation 64. As shown in FIG. 6a, the slicing shoes 61 are interchangeable. The cutting head assembly thus comprises a plurality of slicing shoes, with a first end of each shoe positioned adjacent to a second end of a juxtaposed slicing shoe.

FIG. 6b shows how slicing shoes 61 are juxtaposed to form a gap 65. A first slicing shoe 61a comprises a second end 63, and a second slicing shoe 61b comprises a first end 62. The first end 62 comprises a knife blade 22, which, in turn, comprises a cutting edge 25. The cutting edge 25 is positioned adjacent to the second end 63 of the first slicing shoe 61a to form a gap 65. The width of the gap 65 can be varied along its length to adjust the thickness of sliced product. For example, in FIGS. 6a and 6b, the width 66 of the gap is widest at the bottom, gets narrower from bottom to top along a portion of the gap next to sand gate 71, and widens again at the top, although the gap is not as wide at the top as it is at the bottom. At some points along the gap, the sand gate 71 protrudes behind the cutting edge 25 and is not visible from the viewpoint shown in FIG. 6b; however, even at these points, the gap is still present between the sand gate 71 and cutting edge 25 so that potato slices can pass through the gap as they are cut.

The inventors found that if the angled blades 25 of the present invention are not curved to correspond to the curvature of the wall of the cutting head 12 then the gap 65 between the cutting head and the blade varies in width 66 from top to bottom and results in a sliced product that does not have a substantially constant thickness. This difference occurs because the blade 25 is flat. In other words, it is not curved with the substantially cylindrical wall of the cutting head 12. If the blade were curved or arcuate, the cutting edge 25 could, for example, have a helical shape to provide a constant gap width along a length of the gap 65 (e.g., the length 67 of the gap 65 between the sand gate 71 and the cutting edge 25). In order to provide a constant gap width, it would also be useful to provide an angled sand gate as shown, for example, in FIG. 7a.

Accordingly, one embodiment of the invention comprises a constant gap width of about 1.35 mm. In another embodiment, the gap width is from about 1.30 mm to about 1.40 mm. In another embodiment, the gap width is from about 1.2 mm to about 1.7 mm. In another embodiment, the gap width is from about 0.025″ (0.635 mm) to about 0.250″ (6.35 mm). In another embodiment, the gap width is selected from any of the previously mentioned gap width ranges, or a range whose endpoints are formed by combining some combination of the end points of the previously mentioned gap width ranges, or a gap width that is contained by any of the previously mentioned gap width ranges. Another embodiment comprises angled blades that are curved to match the curvature of walls on a cutting head. Another embodiment comprises angled blades that are curved to provide a substantially constant gap width along a length 67 (e.g. along a portion or the entire length) of the gap 65. Another embodiment comprises angled blades that are curved to produce product slices of substantially one thickness as measured from one sliced surface of the product to an opposite sliced surface of the product. Another embodiment of the invention comprises blades with a helical curve. In one embodiment, the blade 22 is flexible and is clamped to a slicing shoe (e.g., slicing shoe 61b). In one embodiment, a flexible blade 22 can take on a shape that approximates the curvature of the slicing shoe. In some embodiments, a flexible blade 22 is clamped to a slicing shoe 61 to provide a constant gap width 66 along the length 67 of the gap 65 between the cutting edge 25 of the blade 22 and the support 20 at the second end 63 of an adjacent slicing shoe (e.g. the first slicing shoe 61a).

The knife blade 22 is removably secured to a first end of each slicing shoe 61. Each blade 22 can be secured to a slicing shoe by any means known in the art including but not limited to screws or bolts (e.g. bolts 26 of FIG. 6a) having flat heads which fit through openings in a knife blade clamp 27 rigidly attaching the blade 22 to the front, interior side of the slicing shoes 61. In some embodiments, the blade clamp 27 is positioned next to the exterior surface of the blade 22 while a blade holder 27a is positioned next to the interior surface of the blade 22. Together, the blade clamp 27 and blade holder 27a can hold a blade in position. In some embodiments, the blade clamp 27, blade holder 27a, or both are helical or shaped to match the curvature of a surface (e.g. interior surface) of the cutting head 12. In some embodiments, a blade holder 27 and/or clamp 27a are attached to the support 20 of slicing shoe 61 and used to hold or clamp the cutting edge 25 of blade 22 into place so that the cutting edge protrudes past the interior surface of the slicing shoe 61. One skilled in the art, armed with this disclosure will appreciate that any components used to secure (e.g. removably secure) the blade to a slicing shoe or cutting head 12 will conform to the shape of the cutting head 12. In the embodiment shown in FIGS. 6a and 6b the blades are flat and have a cutting edge that is a straight line.

In one embodiment, the blades have either a single or double bias/bevel cutting edge profile. A single bias cutting edge profile means the cutting edge has been provided by sharpening (e.g. by grinding) a blade on one side. Meanwhile, a double bias cutting edge profile means the cutting edge has been provided by sharpening a blade on two sides. For example, given a blade that is originally a rectangular prism, one edge can be given a single bias cutting edge profile by grinding one side of the edge. This grinding will form a cutting edge where the ground side meets the unground side. As another example, a blade sharpened to provide a double bias cutting edge profile can be ground on both sides, and a cutting edge will be formed where the two ground sides meet.

In one embodiment, the shape of the blade clamps matches the shape of the blades. In some embodiments, the blade clamps are flat. Although in other embodiments, the blade clamps follow the wall of a cutting head assembly 12. For example, in one embodiment the cutting head assembly 12 is cylindrical and the blade clamps are helical to provide a constant gap width 66 between a cutting edge 25 and a slicing shoe 61a, which in turn provides slices 44 with parallel cuts on opposite faces.

The knife blade 22 comprises a cutting edge 25 that is angled away from vertical when viewed from the rotational axis 64 of the impeller. Because the blades 22 are angled, each blade takes up more horizontal space along the circumference of the cutting head 12 than the same blade would take up if it were vertically oriented.

FIGS. 7a and 7b depict a second embodiment of the invention comprising angled cutting edges (not shown) and curvilinear sand gates 71a, 71b to protect the cutting head assembly and blades (not shown) from debris. A blade is not explicitly shown to provide a better view of the other components in the Figures. If a blade with a cutting edge were shown in FIG. 7a and FIG. 7b, the blade could be attached to the second slicing shoe 61b using a blade clamp 27 and/or holder 27a. Each point along the cutting edge could be at an angle of tilt 54 away from vertical. In FIGS. 7a, and 7b the angle of tilt 54 is a positive angle. The cutting edge of the blade could be parallel to the trailing edge 72 of the adjacent sand gate 71a so that the cutting edge is at an angle of tilt 54. The cutting edge could also protrude past the interior surface of the slicing shoes 61a, 61b and protrude toward the adjacent sand gate 71a so that potatoes rotating along the interior of the slicing shoes 61a, 61b would be sliced when they contact the cutting edge. In some embodiments, the sand gates 71a, 71b allow debris that is rotated with the potatoes to pass by the blade (e.g. through the ridges) and prevent damage to the blade. In some embodiments, the sand gates have ridges (e.g. square ridges). In some embodiments, the sand gates are provided in wells such as those shown in FIGS. 7a and 7b. Wells are channels that can be cut into a support (e.g. support 20) so that the sand gate sits recessed into the support. In some embodiments, wells permit the sand gates to be flush with the support. In some embodiments, debris that passes through the sand gates 71a, 71b while potatoes are sliced is separated from the sliced potatoes in a separation step (e.g. washing). A first sand gate 71a is secured to a second end 63 of a first slicing shoe 61a. The first slicing shoe 61a is only partially shown. A second sand gate 71b is secured at a second end 63 of a second slicing shoe 61b. As shown in FIGS. 7a and 7b, sand gate 71a conforms to an angle of tilt 54 for the cutting edge (not shown) that the sand gate protects.

Upon aligning the slicing shoes 61a, 61b around a generally circular array similar to that shown in FIG. 6a, a second end 63 of a first slicing shoe 61a lines up correctly with a first end 62 of the adjacent second slicing shoe 61b so as to define a food slicing opening or gap 65, the size of which determines the thickness of a product slice.

Furthermore, in one embodiment, when slicing shoes 61a, 61b are aligned around a generally circular array, a first end 62 of each slicing shoe 61b comprises a knife blade (e.g., blade 22 of FIG. 6a) with a cutting edge (e.g., cutting edge 25 of FIG. 6b) positioned adjacent to a second end 63 of a juxtaposed slicing shoe 61a, which comprises a sand gate 71. As shown in FIG. 7a, the interior of the second slicing shoe 61b depicts a back perspective of a sand gate 71b, showing the angled trailing edge 72 of the sand gate. As shown in FIG. 7b, the exterior of the slicing shoes 61a, 61b provides a front perspective of the first and second sand gates 71a, 71b. This perspective also illustrates the angled trailing edge 72 of a sand gate 71a adjacent to the location for placing an angled blade (e.g., blade 22 of FIG. 6a) that the sand gate 71a that it protects.

In one embodiment, when being used to cut product, the cutting edges 25 of the blades 22 are exposed to product (not shown) at the openings 65 between adjacent slicing shoes such that as product passes by the openings 65, food slices (not shown) are obtained in a continuous and uninterrupted manner. The sand gates 71a, 71b can be removably attached or integral to the slicing shoes 61a, 61b. In some embodiments, the edge of a sand gate adjacent to a cutting edge 25 matches the shape of the cutting edges that it protects. In some embodiments, the edge of a sand gate can be straight, curved or helical. In some embodiment, the sand gate shape is determined through experiment to provide a potato slice with sliced faces that are parallel. In other embodiments, the sand gate shape is determined through modeling to provide a potato slice with sliced faces that are parallel.

FIGS. 7c, 7d, 7e, and 7f depict a third embodiment of the invention with components that have already been generally described, for example, in FIGS. 6a, 6b, 7a and 7b. However, FIGS. 7c, 7d, 7e, and 7f, unlike FIGS. 7a and 7b, also show blades 22 with an angled cutting edge 25. In FIG. 7c, a plurality of slicing shoes 61 are arranged in spaced relation to form a generally cylindrically shaped cutting head 12 for placement around a rotatable impeller of a centrifugal-type slicing machine having an axis of rotation 64. As shown in FIG. 7d, there is a gap 65 between the trailing edge 72 of the sand gate 71 and the cutting edge 25 of blade 22. A clamp 27, in conjunction with a holder 27a (shown in FIG. 7e) helps to hold the blade 25 in place at an angle of tilt 54 (shown in FIG. 7e). FIG. 7f shows a closer view of components shown in FIG. 7e. FIG. 7f shows that the cutting edge 25 of the blade 22 is at an angle of tilt 54 and that the trailing edge 72 of the sand gate 71 is parallel to the cutting edge 25.

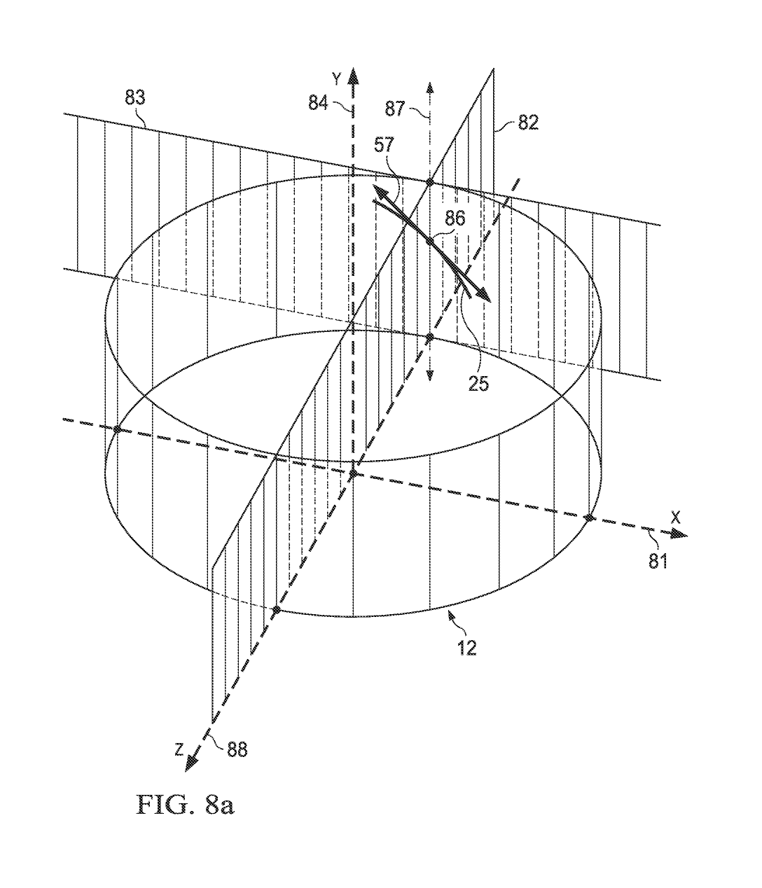

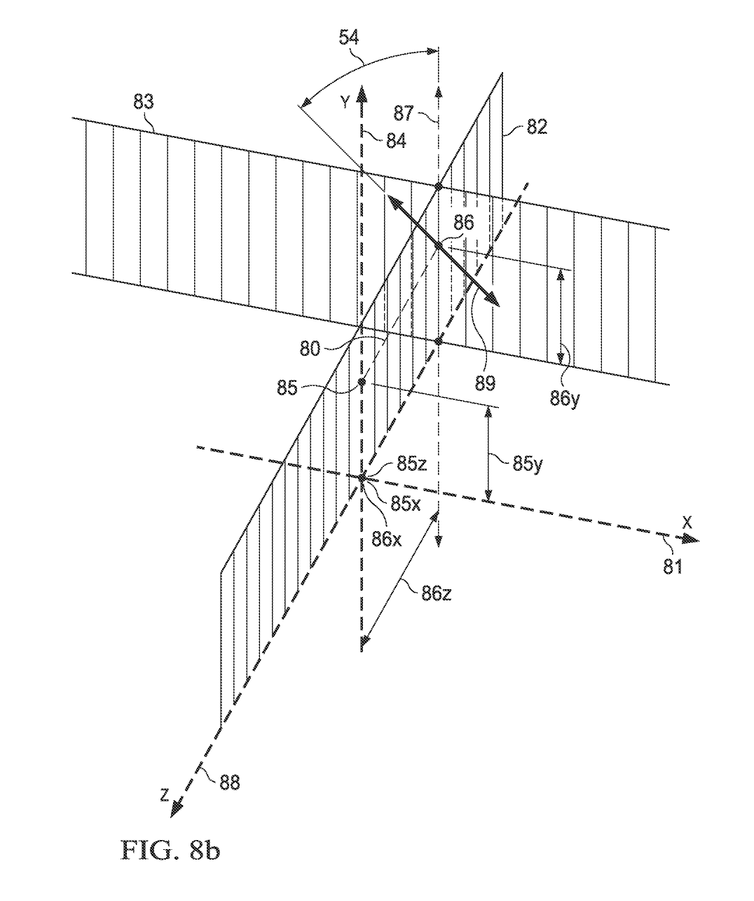

FIG. 8a, shows a schematic of a cutting head 12 with an angled cutting edge 25 with reference to an XYZ Cartesian coordinate system that follows the right-hand rule. A central axis 84 is also the Y-axis of the coordinate system and can also be the axis of rotation 64 for an impeller (not shown). A first plane 82 contains the central axis 84 and also passes through (i.e., intersects) a point 86 on the cutting edge 25. As shown in the example in FIG. 8a, the first plane 82 contains the Z-axis 88 and is perpendicular to the X-axis 81.

A second plane 83 also passes through the point of intersection 86 between the first plane 82 and the cutting edge 25. The second plane 83 is perpendicular to the first plane 82 and parallel to the central axis 84. As shown in the example in FIG. 8a, the second plane 83 is also parallel to the X-axis 81.

A line 57 is tangent to the cutting edge 25 at the point of intersection 86 between the first plane 82 and the cutting edge 25. As shown in FIG. 8b, the tangent 57 to the cutting edge 25 and the first plane 82 form an angle 54 when projected onto the second plane 83. In other words, the projection 89 of the tangent 57 onto the second plane 83 is at an angle 54 to the projection 87 of the first plane 82 onto the second plane 83. Although the first plane 82 and second plane 83 are shown as finite to enhance visibility the planes can actually be infinite. For example, the projection of the first plane 82 onto the second plane 83 can be an infinite line 87 that is parallel to the Y-axis 84.

For ease of reference, it is useful to define several terms. As used herein, a planar projection 82 of a line 84 through a point 86 on a curve (e.g., a cutting edge 25) is a plane 82 containing (and therefore parallel to) the line 84 and passing through (i.e., intersecting) the point 86. For example, as shown in FIGS. 8a and 8b, the first plane 82 is a planar projection of the central axis 84 through a point 86 on the cutting edge 25. As used herein, a linear projection 87 of a first line 84 through a point 86 is a second line 87 that is parallel to the first line 84 and that passes through the point 86. For example, as shown in FIGS. 8a and 8b, the line 87 formed by the intersection between the first plane 82 and the second plane 83 is a linear projection of the central axis 84 through a point 86 on the cutting edge 25. As can be seen in FIGS. 8 and 8b, a planar projection 82 of a first line 84 through a point 86 contains both the first line 82 and a linear projection 87 of the first line 84 to the point 86.

Also, as shown in the example in FIGS. 8a and 8b, the projection 89 of the tangent 57 is an orthogonal projection of the tangent 57 onto the second plane 83. Additionally, the second line 87 is an orthogonal projection of the curve 84 onto the second plane 83. For example, for any point 85 on a curve 84, the orthogonal projection of the point 85 onto the second plane 83 can be found by drawing a normal line 80 from the first point 85 to the second plane 83. The normal line is normal in the sense that it is normal (i.e. perpendicular) to the second plane 83. The point 86 where the normal line 80 to the second plane 83 intersects the second plane 83 is the orthogonal projection of the point 85 onto the second plane 83. The same process can be repeated to map every point on the curve 84 to the second plane 83. The result is an orthogonal projection of the curve 84 onto the second plane 83.

To assist in visualizing how the point 86 is an orthogonal projection of the point 85 onto the second plane 83, FIG. 8b shows the coordinates of the two points. For example, the point 85 on the Y-axis 84 has an X-coordinate 85x at the origin of the X-axis, a Y-Coordinate a positive distance 85y along the Y-axis 84, and a Z-Coordinate 85z at the origin of the Z-axis 88. The point 86 on the second plane 83 has an X-coordinate 86x at the origin of the X-axis, a Y-Coordinate a positive distance 86y along the Y-axis 84, and a Z-Coordinate a negative distance 86z along the Z-axis 88. As can be seen for the example in FIG. 8b, the X-Coordinates and the Y-Coordinates of both points 85, 86 are the same.

### Comparative Examples

In one embodiment, the slicing shoes of the present invention can be used with a centrifugal-type slicing system as disclosed above. In one embodiment, the slicing shoes and assembly of the present invention are utilized to conform to a centrifugal slicing system.

In one embodiment, the slicing shoes and cutting head assembly provide for an improved method of slicing food product with a centrifugal-type slicing machine. At least one food product is inserted into an impeller, which is caused to rotate such that the at least one food product is forced away from the axis of rotation due to centrifugal forces. The food product moves towards the interior wall surface of supports of said slicing shoes. The food product is then sliced by the angled cutting edges of the knife blades attached to the supports of the slicing shoes.

In some embodiments, to create food products with various sizes and shapes, blades having different shapes, widths and depths can be used with corresponding components to form the stationary cutting assembly. In other embodiments, a plurality of blades having the same or different shapes, widths, lengths and depths (or thicknesses) can be used with corresponding components to form the stationary cutting assembly. For example, in some embodiments, a blade can be smooth. In other embodiments, a blade can be serrated. In other embodiments, a blade can comprise curves, waves or ruffles, for example, to cut potato chips with corresponding shapes. In some embodiments, a single blade comprises a shape that comprises a plurality of shape features, for example, some combination of shape features selected from the group of shape features consisting of curves, waves, and ruffles. In other embodiments, a single blade comprises a single shape feature.

In one embodiment a slicing blade impacts potatoes at 4.5 m/s. However, in other embodiments the impact speed can be higher or lower. For example in some embodiments, the rotational velocity of the impeller that rotates potatoes is from about 200 to about 265 rpm. In other embodiments, the rotational velocity is from about 200 to about 300 rpm. In some embodiments the diameter is about 355 mm, although the diameter can also be different sizes. In one embodiment, the impact between a potato and a slicing blade occurs near the cutting head wall (e.g., a distance before the wall if the cutting edge protrudes inside the cutting head). Accordingly, in one embodiment, the impact velocity between the cutting edge and a potato is approximately equal to the translational velocity of the potato (e.g., the product of the distance from the potato to the axis of rotation times the rotational velocity of an impeller that rotates the potato). For example, in some embodiments, the translational velocity of the potato that is being sliced is approximately equal to the product of Π times the diameter of the cutting head times the rotational velocity (rotations/time) of the impeller inside the cutting head. In one embodiment the translational velocity (or impact velocity) of the potato when it impacts the cutting edge is about 3.7 m/s to about 4.9 m/s, about 4.0 m/s to about 4.5 m/s, or a range formed by combining any of the endpoints of the velocity ranges. In one embodiment, the translational velocity (or impact velocity) of the potato when it impacts the cutting edge is about 4.35 m/s. In some embodiments the invention allows the impact speed to be increased so that potatoes are cut more quickly while the yield is greater than it would otherwise be. Although the yield should be decreased by increasing the impact speed, in some embodiments, the impact speed is increased, but the yield is not reduced or the yield is even increased.

In one embodiment, the relative speed of a potato to a cutting head and the relative cutting force on the cutting head can be reduced by co-rotating a cutting head and an impeller in the same direction. For example, in some embodiments, an angled cutting edge can be used in combination with a cutting head that rotates in the same direction as an impeller. Co-rotation of the cutting head and the impeller (and the potatoes inside the cutting head) can also decrease the speed at which potatoes impact the cutting head. Thus, co-rotation, for example, as described in U.S. Pat. No. 4,604,925 to Lawrence W. Wisdom, can be used with the angled cutting edges described herein. However, as noted earlier, slowing down the relative velocity of the potatoes to the cutting head can decrease throughput. Accordingly, it can still be desirable to use an angled cutting edge without co-rotation of the impeller and cutting head.

In one embodiment of the invention, the cutting edge of an angled blade remains in good condition for a longer time than the cutting edge of a blade that is not angled relative to the cutting direction. For example, given an angled blade according to the invention and a non-angled blade traveling at a given speed in the cutting direction, the cutting edge of the non-angled blade is damaged or destroyed in minutes as indicated by examination under a microscope. For example, some non-angled blades have a life of about 60 to about 120 minutes at standard throughput rates (e.g. 6000 lbs of potatoes per hour) using a centrifugal slicer. Illustrative examples of physical characteristics that indicate damage to a blade include the blade edge folding over, the edge dulling, the edge no longer being pointed, the edge being rounded, pitting, micro-pitting, nicks, micro-nicks, blunting, and chipping. Another physical characteristic that can indicate that a blade will result in reduced cutting yield or effectiveness is the buildup of debris on the blade. In contrast, angled blades of the invention last substantially longer. In some embodiments, the inventors believe that the angled blades will last at least about 5% longer, at least about 10% longer, at least about 15% longer, at least about 25% longer, at least about 35% longer, at least about 45% longer, at least about 50% longer, or at least about 15% to about 50% longer than a non-angled blade otherwise operating under similar conditions.

In one embodiment, the invention has an improved ability to cut vegetables that tend to mush rather than being cut. For example, in one embodiment the invention is useful for cutting tomatoes. When tomatoes are cut with the typical blade, the blade tends to dull after 2 to 3 cuts and tomatoes are mushed rather than sliced. However, in one embodiment of the invention, the angled blades are able to slice tomatoes longer than a typical blade without dulling.

In one embodiment, the walls of the slicer are angled out from bottom to top so that products tend to travel up the wall of the cutting head as they are being cut. Accordingly, the cutting direction is no longer horizontal and even a vertical cutting edge is at an angle to the cutting direction. In some embodiments, the angle of the walls and the angle of the cutting edge to the direction of the rotation of the impeller can both be combined to result in an effective angle between the cutting edge and the cutting direction. In some embodiments, the effective angle is greater than the angle of the walls to the direction of rotation and the angle of the cutting edge to the direction of rotation. Accordingly, in some embodiments, the effective angle reduces the cutting forces on products that are cut at the effective angle relative to products that are cut at an angle resulting from only an angled blade or only an angled wall. Although, an embodiment has been described in which the products travel up the wall, in other embodiments the walls of the slicer are angled in from bottom to top so that products tend to travel down the wall of the cutting head as they are being cut

It is to be understood that in addition to being angled away from vertical, the angle or shape of one or more blades in a cutting assembly can vary according to desired shape or type of food product used. Further, any combination of the novel blades can be used around the cutting assembly to maximize the number of shapes achieved.

In some embodiments, the impeller and cutting head are coaxial. For example, the impeller can be coaxially mounted inside the cutting head. Accordingly, in some embodiments, the central axis of the cutting head is the axis of rotation for the impeller.

In some embodiments, a portion of a cutting edge comprises a plurality of points, wherein for each point in the plurality of points, a corresponding plane for the point passes through the point and contains the central axis of the cutting head. In some embodiments, for each point in the plurality of points, as viewed from the central axis and along the corresponding plane for the point, a tangent to the cutting edge at the point is at an angle to the corresponding plane.

In some embodiments, a cutting edge is inwardly directed towards the impeller to slice at least one food product in a cutting direction at each point along a length of the cutting edge, and a tangent to the cutting edge is oriented at an angle away from a normal plane to the cutting direction at each point along a portion of the length of the cutting edge, thereby producing sliced food products.

In some embodiments, a portion of the cutting edge is continuous. For example, the portion is a curve with no discontinuities. However, in some embodiments, the portion of the cutting edge is discontinuous. In other words it is a curve with discontinuities. For example, if a cutting edge were a semi-circular shape, a point on the cutting edge can have a tangent to the cutting edge that is not at an angle to a plane. Furthermore, the point can separate two regions along the semi-circular cutting edge that both consist of a plurality of points on the cutting edge with tangents that are at an angle to the plane. Accordingly, the point is a discontinuity between two regions of the cutting edge that are at an angle to the plane. Thus, the portion of the cutting edge that comprises the regions has a discontinuity. Although, in some embodiments a discontinuous portion of the cutting edge has a single discontinuity, in some embodiments a discontinuous portion of the cutting edge has a plurality of discontinuities.

As another example, if a cutting edge were a serrated shape, each point in a first plurality of points on the cutting edge can have a tangent to the cutting edge that is at an angle to a plane, and these points can be separated by a second plurality of points, such that each point in the second plurality of points has a tangent to the cutting edge that is not at an angle to the plane. Furthermore, the second plurality of points can separate a plurality of angled regions along the cutting edge that consist of points from the first plurality of points. Accordingly, the points in the second plurality of points form discontinuities between the angled regions. Thus, the portion of the cutting edge that comprises the angled regions has discontinuities.

Although some embodiments may comprise discontinuities, for example the embodiments described above, in other embodiments the angled portion of a blade does not comprise discontinuities.

### Experiments

Several experiments were conducted to measure the yield of potatoes cut using blades at different angles. Because the yield experiments destroy potato samples, the exact same potato samples are not used for measuring the yield of both an angled blade and a non-angled blade. However, the experiments use standardization and randomization to reduce the effects that potato variability might have on a measured yield. For example, the experiments used potatoes that were standardized in the sense that the potatoes were all of the same type of potato and all from the same field. The experiments were also random in the sense that the potatoes used with the angled blade and the potatoes used with the non-angled blade were randomly selected.

Micro mass balances were used to measure the yield obtained from cutting a batch of potatoes at a given blade angle. A micro mass balance involves weighing a batch of potatoes in a water bath, slicing the potatoes, and then reweighing the sliced potatoes in a water bath after cutting. The yield is equal to the mass after cutting divided by the mass before cutting and expressed as a percentage. The yield loss is obtained by subtracting the mass after cutting from the mass before cutting to obtain a difference, dividing the difference by the mass before cutting, and expressing the result as a percentage. Measuring using a water bath serves to measure the dry matter in the potatoes and exclude variations in mass caused by water content or water on the surface of the potatoes.

### Experimental Set 1

One embodiment of the invention involved a hand slicer in which the blade was angled up to 45° away from vertical relative to a horizontal cutting direction. This embodiment showed a yield improvement 0.5% to 1.2% for cutting potatoes. As used herein, the term “yield” refers to the fractional weight calculated by dividing the weight of a sliced product by the weight the product before it was sliced and expressing the result as a percentage. As used herein, the term “yield loss” refers to the weight percentage of a product lost due to cutting.

The inventors conducted several experiments to measure the yield loss from cutting using blades with both angled cutting edges and non-angled cutting edges relative to the plane that is perpendicular (i.e. normal) to the cutting direction. The experiments were randomized and used standard potatoes grown in the same field. The same hand-slicing apparatus was used in conjunction with both non-angled and angled blades. For example, some potatoes were cut using a blade perpendicular to the cutting direction (i.e. a non-angled blade) and other potatoes were cut using a blade at an angle away from the plane that is perpendicular to the cutting direction.

The experiments were conducted using the same hand slicer for slicing and the same cutting conditions apart from the blade angle. For example, slicing with both the angled blade and non-angled blade involved slicing in the same cutting direction and applying approximately the same total force to each potato when pushing the potatoes against the hand slicer. This is not to say, however, that the cutting forces were the same for the various blade angles. As described earlier with respect to FIGS. 5a and 5b, the cutting force for the angled blade was reduced relative to the cutting force for the non-angled blade.

In some embodiments, the reduction in yield loss caused by cutting with an angled blade using a centrifugal slicer is expected to be 0.18% to 1.2%, 0.2% to 0.95%, 0.5% to 0.56%, or any range formed by combining the endpoints of any of these ranges. In some embodiments, the reduction in yield loss caused by cutting with an angled blade is at least 0.18%, 0.2%, 0.5%, 0.56%, 0.95%, or 1.2%.

### Experimental Set 3

Several experiments were also conducted using a mechanical arm to slice potatoes and measure the reduction in cutting force that results from cutting with an angled blade as opposed to a non-angled blade. For these experiments, the cutting direction was vertical and the blade angle was measured away from horizontal. However, the mechanics of both vertical and horizontal cutting directions are sufficiently similar that experimental data using a vertical cutting direction is indicative of the increased yield that can be expected when using a horizontal cutting direction.

The experiments were conducted using the same mechanical arm for slicing and the same cutting conditions apart from the blade angle. For example, slicing with both the angled blade and non-angled blade involved slicing in the same cutting direction and applying the same total force with the mechanical arm. This is not to say, however, that the cutting forces were the same for the various blade angles. As described earlier with respect to FIGS. 5a and 5b, the cutting force for the angled blade was reduced relative to the cutting force for the non-angled blade.

In one experiment, the reduction in cutting force for an angled blade relative to a non-angled blade (i.e. 0°) was measured using a blade fixed to a mechanical arm. The blade was modified to have a blade angled at 0°, 30°, and 45° away from the plane that is normal to the cutting direction. During the experiment, 5 potatoes were cut 3 times at each angle. This resulted in a total of 15 cuts per angle. Cutting with an angled cutting edge reduced the cutting force relative to cutting with a non-angled cutting edge.

Unless otherwise indicated, all numbers expressing angles, distances and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. Notwithstanding that the numerical ranges and parameters setting forth the broad scope of the invention are approximations, the numerical values set forth in the specific examples are reported reasonably precisely. Any numerical value, however, inherently contains certain errors necessarily resulting from the standard deviation found in their respective testing measurements.

While this invention has been particularly shown and described with reference to preferred embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### Additional Embodiments

Additional embodiments of the invention are listed below.

1. A cutting head, with a central axis, an interior, an exterior, a top, and a bottom, for slicing food product to form sliced food product, said cutting head comprising:

at least one blade secured to the cutting head,

wherein the at least one blade comprises a cutting edge inwardly directed towards the interior of the cutting head and oriented to cut the food product as the food product rotates along the interior of the cutting head in a direction of rotation,

wherein a portion of the cutting edge comprises a plurality of points,

wherein for each point in the plurality of points, a corresponding plane for the point passes through the point and contains the central axis, and

wherein for each point in the plurality of points, as viewed from the central axis and along the corresponding plane for the point, a tangent to the cutting edge at the point is at an angle to the corresponding plane.

2. A cutting head, with a central axis, an interior, an exterior, a top, and a bottom, for slicing food product to form sliced food product, said cutting head oriented with respect to a first plane that is a planar projection of the central axis through a point on the cutting head, said cutting head oriented with respect to a second plane, which second plane also passes through the point, which second plane is perpendicular to the first plane, and which second plane is parallel to the central axis, and said cutting head oriented with respect to a first line that is an orthogonal projection of the central axis onto the second plane and passes through the point, said cutting head comprising:

at least one blade secured to the cutting head, wherein the at least one blade comprises a cutting edge,

wherein the cutting edge is inwardly directed towards the interior of the cutting head and oriented to cut the food product as the food product rotates along the interior of the cutting head in a direction of rotation,

wherein the point on the cutting head is a point on the cutting edge,

wherein a second line is a tangent to the cutting edge at the point,

wherein a third line is an orthogonal projection of the second line onto the second plane,

wherein, for each point along a portion of the cutting edge, the first line and the third line are at an angle.

3. A method for making a sliced food product using a centrifugal-type slicing machine, said slicing machine having an impeller with an axis of rotation surrounded by a cutting head, said cutting head comprising at least one slicing shoe, wherein each said at least one slicing shoe has an interior, an exterior, a top, a bottom, a first end, a second end, and at least one blade secured to the first end of said slicing shoe, said method comprising the steps of:

a) inserting at least one food product into said cutting head;

b) causing said impeller to rotate such that the at least one food product is forced away from the axis of rotation and towards the interior of said at least one slicing shoe; and

c) slicing said at least one food product with a cutting edge of said at least one blade, wherein the cutting edge is inwardly directed towards the impeller to slice the at least one food product in a cutting direction at each point along a length of the cutting edge, and wherein a tangent to the cutting edge is oriented at an angle away from a normal plane to the cutting direction at each point along a portion of the length of the cutting edge, thereby producing sliced food products.

4. A slicing shoe having first and second ends for use with a centrifugal-type slicer, said centrifugal-type slicer having a cutting head and an impeller, which impeller rotates unsliced food products against the cutting head in a direction of rotation for the production of sliced food products, said slicing shoe comprising:

a blade with a cutting edge inwardly directed towards the impeller, said cutting edge oriented to slice the unsliced food products in a cutting direction at each point along a length of the cutting edge, wherein a tangent to the cutting edge is oriented at an angle away from a normal plane to the cutting direction at each point along a portion of the length of the cutting edge.

5. An additional embodiment, according to any of the additional embodiments 1-4, further comprising at least one sand gate secured to the cutting head.
6. The sand gate of claim 5, wherein said at least one sand gate comprises an interior concave surface matching an exterior surface of a blade in the group consisting of the at least one blade.
7. An additional embodiment, according to any of the additional embodiments 1-4, wherein the at least one blade is flat, the cutting edge is a line, and the tangent to the cutting edge is the cutting edge.
8. An additional embodiment, according to any of the additional embodiments 1-4, wherein the at least one blade is curved to provide a cutting edge that is helical.
9. An additional embodiment, according to any of the additional embodiments 1-4, wherein the blade is flexible and conforms to a shape of the cutting head to provide a gap with an approximately constant width along a length of the gap so that the sliced food product which passes through the gap as the food product is cut has substantially parallel, sliced faces.
10. An additional embodiment, according to any of the additional embodiments 1-4, wherein the direction of rotation is horizontal and the cutting edge is at an angle away from vertical.
11. An additional embodiment, according to any of the additional embodiments 1-4, wherein slicing food product with the cutting head results in a reduction in yield loss.
12. An additional embodiment, according to additional embodiment 11, wherein the reduction in yield loss is at least 1.2%.
13. An additional embodiment, according to additional embodiment 11, wherein the reduction in yield loss is 0.18% to 1.2%.
14. An additional embodiment, according to any of the additional embodiments 1-4, wherein the food product is produce.
15. An additional embodiment, according to any of the additional embodiments 1-4, wherein the food product is selected from the group consisting of potatoes, apples, pears, beets, yucca, sweet potatoes, tomatoes, mangos, eggplants, cucumbers, zucchinis, or some combination thereof.
16. An additional embodiment, according to any of the additional embodiments 1-4, wherein, when the cutting edge slices food product, a total force of the food product against the cutting edge has a component parallel to the cutting edge to provide a cleaning force.
17. An additional embodiment, according to any of the additional embodiments 1-4, wherein a gap is present between the cutting edge and another component of the cutting head such that sliced food product passes through the gap when food product is cut by the cutting edge.
18. An additional embodiment, according to additional embodiment 17, wherein said another component of the cutting head is a support.
19. An additional embodiment, according to additional embodiment 17, wherein said another component of the cutting head is a sand gate.
20. An additional embodiment, according to additional embodiment 17, wherein a width of the gap is constant along a length of the gap.
21. An additional embodiment, according to additional embodiment 17, wherein the length of the gap is an entire length of the cutting edge.
22. An additional embodiment, according to any of the additional embodiments 1-4, wherein the portion of the cutting edge is the entire length of the cutting edge.
23. An additional embodiment, according to any of the additional embodiments 1-4, wherein the portion of the cutting edge is less than an entire length of the cutting edge.
24. An additional embodiment, according to additional embodiment 23, wherein the portion of the cutting edge is greater than 50% of the length of the cutting edge.
25. An additional embodiment, according to additional embodiment 23, wherein the portion of the cutting edge is greater than 66% of the length of the cutting edge.
26. An additional embodiment, according to additional embodiment 23, wherein the portion of the cutting edge is greater than 75% of the length of the cutting edge.
27. An additional embodiment, according to additional embodiment 23, wherein the portion of the cutting edge is greater than 90% of the length of the cutting edge.
28. An additional embodiment, according to additional embodiment 23, wherein the portion of the cutting edge is greater than 95% of the length of the cutting edge.
29. An additional embodiment, according to additional embodiment 23, wherein the portion of the cutting edge is greater than 99% of the length of the cutting edge.
30. An additional embodiment, according to any of the additional embodiments 1-4, wherein the portion of the cutting edge is continuous.
31. An additional embodiment, according to any of the additional embodiments 1-4, wherein the portion of the cutting edge is discontinuous.
32. An additional embodiment, according to any of the additional embodiments 1-4, wherein for each point along the portion of the cutting edge, the angle is the same angle.
33. An additional embodiment, according to any of the additional embodiments 1-4, wherein for each point in the portion of the cutting edge, the angle between the tangent to the cutting edge at the point and the corresponding plane is one of a plurality of angles.
34. An additional embodiment, according to any of the additional embodiments 1-4, wherein the angle is from greater than 0° to less than 90°.
35. An additional embodiment, according to any of the additional embodiments 1-4, wherein the angle is from greater than 90° to less than 180°.
36. An additional embodiment, according to any of the additional embodiments 1-4, wherein the angle is from greater than 180° to less than 270°.
37. An additional embodiment, according to any of the additional embodiments 1-4, wherein the angle is from greater than 270° to less than 360°.
38. An additional embodiment, according to any of the additional embodiments 1-4, wherein the angle is from greater than 0° to about positive 45° or less than 0° to about negative 45°.
39. An additional embodiment, according to any of the additional embodiments 1-4, wherein the angle is from 135° to less than 180°.
40. An additional embodiment, according to any of the additional embodiments 1-4, wherein the angle is from greater than 180° to 225°.
41. An additional embodiment, according to any of the additional embodiments 1-4, wherein the angle is from greater than 270° to 315°.
42. An additional embodiment, according to any of the additional embodiments 1-4, wherein the cutting blade remains sharp for a longer period of time under the same cutting conditions than the period of time the cutting blade would remain sharp if it were not at an angle.
43. An additional embodiment, according to any of the additional embodiments 1-4, wherein the interior of the cutting head comprises a wall and wherein the wall is angled away from the central axis from the bottom to the top of the cutting head so that, when the cutting head is used to slice food product, the food product tends to travel up the wall of the cutting head as the food product is being sliced.
44. An additional embodiment, according to any of the additional embodiments 1-4, wherein the interior of the cutting head comprises a wall and wherein the wall is angled toward the central axis from the bottom to the top of the cutting head so that, when the cutting head is used to slice food product, the food product tends to travel down the wall of the cutting head as the food product is being sliced.
45. An additional embodiment, according to any of the additional embodiments 1-4, wherein the cutting head is stationary.
46. An additional embodiment, according to any of the additional embodiments 1-4, wherein the cutting head comprises a plurality of slicing shoes, wherein each slicing shoe comprises a blade.
47. An additional embodiment, according to additional embodiment 40, wherein the slicing shoes are interchangeable.
48. An additional embodiment, according to additional embodiment 40, wherein each slicing shoe comprises a support with the blade secured to a first end of said support.
49. An additional embodiment, according to any of the additional embodiments 1-4, wherein the at least one blade comprises a cutting edge oriented opposite the direction of rotation.
50. An additional embodiment, according to any of the additional embodiments 1-4, wherein the cutting head is cylindrical.
51. An additional embodiment, according to any of the additional embodiments 1-4, wherein said at least one blade further comprises an interior surface and an exterior surface, and wherein said surfaces are parallel.
52. An additional embodiment, according to any of the additional embodiments 1-4, wherein said cutting head comprises a support having a concave interior surface, wherein an interior surface of said at least one blade comprises a curvature matching a curvature of said interior surface of the support, and wherein said at least one blade is secured to a first end of said support.
53. An additional embodiment, according to any of the additional embodiments 1-4, wherein the angle is selected from angles in the group consisting of the range of angles from greater than 0° to 45°, from 135° to less than 180°, from greater than 180° to 225°, and from greater than 270° to 315°.
54. An additional embodiment, according to any of the additional embodiments 1-4, wherein the at least one blade is curved to provide a gap with an approximately constant width along a length of the gap so that the sliced food product which passes through the gap as the food product is cut has substantially parallel, sliced faces.
55. An additional embodiment, according to any of the additional embodiments 1-4, wherein slicing food product with the cutting head results in a reduction in yield loss of at least 0.5%.

We claim:

1. A cutting head, with a central axis, an interior, an exterior, a top, and a bottom, for slicing food product to form sliced food product, said cutting head comprising:
at least one blade secured to the cutting head,
wherein the at least one blade comprises a cutting edge inwardly directed towards the interior of the cutting head and oriented to cut the food product as the food product rotates along the interior of the cutting head in a direction of rotation,
wherein a portion of the cutting edge comprises a plurality of points,
wherein for each point in the plurality of points, a corresponding plane for the point passes through the point and contains the central axis, and
wherein for each point in the plurality of points, as viewed from the central axis and along the corresponding plane for the point, a tangent to the cutting edge at the point is at an angle to the corresponding plane.

2. The cutting head of claim 1, wherein the at least one blade is curved to provide a gap with an approximately constant width along a length of the gap so that the sliced food product which passes through the gap as the food product is cut has substantially parallel, sliced faces.

3. The cutting head of claim 1, wherein slicing food product with the cutting head results in a reduction in yield loss of at least 0.5%.

4. The cutting head of claim 1, wherein, when the cutting edge slices food product, a total force of the food product against the cutting edge has a component parallel to the cutting edge to provide a cleaning force.

5. The cutting head of claim 1, wherein a gap is present between the cutting edge and another component of the cutting head such that sliced food product passes through the gap when food product is cut by the cutting edge, and wherein a width of the gap is constant along an entire length of the gap.

6. The cutting head of claim 1, wherein the portion of the cutting edge is less than an entire length of the cutting edge, greater than 50% of the cutting edge and continuous.

7. The cutting head of claim 1, wherein for each point along the portion of the cutting edge, the angle is the same angle.

8. The cutting head of claim 1, wherein the angle is greater than 0° to about positive 45° or less than 0° to about negative 45°.

9. The cutting head of claim 1, wherein the interior of the cutting head comprises a wall and wherein the wall is angled away from or towards the central axis from the bottom to the top of the cutting head so that, when the cutting head is used to slice food product, the food product tends to travel up or down, respectively, the wall of the cutting head as the food product is being sliced.

10. The cutting head of claim 1, wherein the cutting head is cylindrical and stationary, wherein the cutting head comprises a plurality of slicing shoes, wherein each slicing shoe comprises a blade, and wherein the slicing shoes are interchangeable.

11. A cutting head, with a central axis, an interior, an exterior, a top, and a bottom, for slicing food product to form sliced food product, said cutting head oriented with respect to a first plane that is a planar projection of the central axis through a point on the cutting head, said cutting head oriented with respect to a second plane, which second plane also passes through the point, which second plane is perpendicular to the first plane, and which second plane is parallel to the central axis, and said cutting head oriented with respect to a first line that is an orthogonal projection of the central axis onto the second plane and passes through the point, said cutting head comprising:
at least one blade secured to the cutting head, wherein the at least one blade comprises a cutting edge,
wherein the cutting edge is inwardly directed towards the interior of the cutting head and oriented to cut the food product as the food product rotates along the interior of the cutting head in a direction of rotation,
wherein the point on the cutting head is a point on the cutting edge,
wherein a second line is a tangent to the cutting edge at the point,
wherein a third line is an orthogonal projection of the second line onto the second plane,
wherein, for each point along a portion of the cutting edge, the first line and the third line are at an angle.

12. The cutting head of claim 11, wherein the at least one blade is curved to provide a gap with an approximately constant width along a length of the gap so that the sliced food product which passes through the gap as the food product is cut has substantially parallel, sliced faces.

13. The cutting head of claim 11, wherein slicing food product with the cutting head results in a reduction in yield loss of at least 0.5%.

14. The cutting head of claim 11, wherein, when the cutting edge slices food product, a total force of the food product against the cutting edge has a component parallel to the cutting edge to provide a cleaning force.

15. The cutting head of claim 11, wherein a gap is present between the cutting edge and another component of the cutting head such that sliced food product passes through the gap when food product is cut by the cutting edge, and wherein a width of the gap is constant along an entire length of the gap.

16. The cutting head of claim 11, wherein the portion of the cutting edge is less than an entire length of the cutting edge, greater than 50% of the cutting edge and continuous.

17. The cutting head of claim 11, wherein for each point along the portion of the cutting edge, the angle is the same angle.

18. The cutting head of claim 11, wherein the angle is greater than 0° to about positive 45° or less than 0° to about negative 45°.

19. The cutting head of claim 11, wherein the interior of the cutting head comprises a wall and wherein the wall is angled away from or towards the central axis from the bottom to the top of the cutting head so that, when the cutting head is used to slice food product, the food product tends to travel up or down, respectively, the wall of the cutting head as the food product is being sliced.

20. The cutting head of claim 11, wherein the cutting head is cylindrical and stationary, wherein the cutting head comprises a plurality of slicing shoes, wherein each slicing shoe comprises a blade, and wherein the slicing shoes are interchangeable.

21. A method for making a sliced food product using a centrifugal-type slicing machine, said slicing machine having an impeller with an axis of rotation surrounded by a cutting head, said cutting head comprising at least one slicing shoe, wherein each said at least one slicing shoe has an interior, an exterior, a top, a bottom, a first end, a second end, and at least one blade secured to the first end of said slicing shoe, said method comprising the steps of:
a) inserting at least one food product into said cutting head;
b) causing said impeller to rotate such that the at least one food product is forced away from the axis of rotation and towards the interior of said at least one slicing shoe; and
c) slicing said at least one food product with a cutting edge of said at least one blade, wherein the cutting edge is inwardly directed towards the impeller to slice the at least one food product in a cutting direction at each point along a length of the cutting edge, and wherein a tangent to the cutting edge is oriented at an angle away from a normal plane to the cutting direction at each point along a portion of the length of the cutting edge, thereby producing sliced food products.

22. The cutting head of claim 21, wherein the at least one blade is curved to provide a gap with an approximately constant width along a length of the gap so that the sliced food product which passes through the gap as the food product is cut has substantially parallel, sliced faces.

23. The cutting head of claim 21, wherein slicing food product with the cutting head results in a reduction in yield loss of at least 0.5%.

24. The cutting head of claim 21, wherein, when the cutting edge slices food product, a total force of the food product against the cutting edge has a component parallel to the cutting edge to provide a cleaning force.

25. The cutting head of claim 21, wherein a gap is present between the cutting edge and another component of the cutting head such that sliced food product passes through the gap when food product is cut by the cutting edge, and wherein a width of the gap is constant along an entire length of the gap.

26. The cutting head of claim 21, wherein the portion of the cutting edge is less than an entire length of the cutting edge, greater than 50% of the cutting edge and continuous.

27. The cutting head of claim 21, wherein for each point along the portion of the cutting edge, the angle is the same angle.

28. The cutting head of claim 21, wherein the angle is greater than 0° to about positive 45° or less than 0° to about negative 45°.

29. The cutting head of claim 21, wherein the interior of the cutting head comprises a wall and wherein the wall is angled away from or towards the central axis from the bottom to the top of the cutting head so that, when the cutting head is used to slice food product, the food product tends to travel up or down, respectively, the wall of the cutting head as the food product is being sliced.

30. The cutting head of claim 21, wherein the cutting head is cylindrical and stationary, wherein the cutting head comprises a plurality of slicing shoes, wherein each slicing shoe comprises a blade, and wherein the slicing shoes are interchangeable.

31. A slicing shoe having first and second ends for use with a centrifugal-type slicer, said centrifugal-type slicer having a cutting head and an impeller, which impeller rotates unsliced food products against the cutting head in a direction of rotation for the production of sliced food products, said slicing shoe comprising:
a blade with a cutting edge inwardly directed towards the impeller, said cutting edge oriented to slice the unsliced food products in a cutting direction at each point along a length of the cutting edge, wherein a tangent to the cutting edge is oriented at an angle away from a normal plane to the cutting direction at each point along a portion of the length of the cutting edge.

32. The cutting head of claim 31, wherein the at least one blade is curved to provide a gap with an approximately constant width along a length of the gap so that the sliced food product which passes through the gap as the food product is cut has substantially parallel, sliced faces.

33. The cutting head of claim 31, wherein slicing food product with the cutting head results in a reduction in yield loss of at least 0.5%.

34. The cutting head of claim 31, wherein, when the cutting edge slices food product, a total force of the food product against the cutting edge has a component parallel to the cutting edge to provide a cleaning force.

35. The cutting head of claim 31, wherein a gap is present between the cutting edge and another component of the cutting head such that sliced food product passes through the gap when food product is cut by the cutting edge, and wherein a width of the gap is constant along an entire length of the gap.

36. The cutting head of claim 31, wherein the portion of the cutting edge is less than an entire length of the cutting edge, greater than 50% of the cutting edge and continuous.

37. The cutting head of claim 31, wherein for each point along the portion of the cutting edge, the angle is the same angle.

38. The cutting head of claim 31, wherein the angle is greater than 0° to about positive 45° or less than 0° to about negative 45°.

39. The cutting head of claim 31, wherein the interior of the cutting head comprises a wall and wherein the wall is angled away from or towards the central axis from the bottom to the top of the cutting head so that, when the cutting head is used to slice food product, the food product tends to travel up or down, respectively, the wall of the cutting head as the food product is being sliced.

40. The cutting head of claim 31, wherein the cutting head is cylindrical and stationary, wherein the cutting head comprises a plurality of slicing shoes, wherein each slicing shoe comprises a blade, and wherein the slicing shoes are interchangeable.
